(19) United States
(12) Patent Application Publication
(10) Pub. No.: US 2012/0235955 A1
(43) Pub. Date: Sep. 20, 2012

(54) OPTICAL NAVIGATION MODULE

(75) Inventors: Pak Hong NG, Hong Kong (HK); Xiaoming Yvonne Yu, Hong Kong (HK); Wai Vincent Hung, Hong Kong (HK)

(73) Assignee: SAE Magnetics (H.K.) Ltd.

(21) Appl. No.: 13/049,899

(22) Filed: Mar. 17, 2011

(51) Int. Cl. G06F 3/042

(52) U.S. Cl. 345/175

(57) ABSTRACT

An optical navigation module for receiving control from an object is provided. The optical navigation module includes a module surface above which the object is disposed; a light source located under the module surface and configured to project a first cone of light to the object along a first optical axis through a first optical construction; and a light sensor located under the module surface and configured to detect a second cone of light that is resulted from the first cone of light being reflected by the object along a second optical axis through a second optical construction, and thereby to collect a spatial intensity profile of the reflected light. The intersection of the first optical axis and the second optical axis is below the module surface.

### FIELD OF THE PATENT APPLICATION

The present patent application relates to an optical navigation module and more particularly to an optical navigation module that has a compact size and a desired small sensing range without sacrificed sensor sensitivity.

### BACKGROUND

Optical navigation module is an essential component of consumer electronics requiring user input through a GUI (Graphical User Interface). Existing designs usually have light sensors configured to receive reflected light as much as possible while the sensing range is not in consideration.

However, in many applications, the sensing range of the optical navigation module has to be taken as a main consideration. In these cases, the sensing range needs to be limited to a usable range. Electrical methods such as reducing the sensor sensitivity have been developed to limit the sensing range. On the other hand, it is desired to have a small sized optical navigation module for which the sensing range can be limited to a usable range simply by optical methods rather than electrical methods so that the sensor sensitivity is not sacrificed.

### SUMMARY

The present patent application is directed to an optical navigation module for receiving control from an object. In one aspect, the optical navigation module includes a module surface above which the object is disposed; a light source located under the module surface and configured to project a first cone of light to the object along a first optical axis through a first optical construction; and a light sensor located under the module surface and configured to detect a second cone of light that is resulted from the first cone of light being reflected by the object along a second optical axis through a second optical construction, and thereby to collect a spatial intensity profile of the reflected light. The intersection of the first optical axis and the second optical axis is below the module surface.

The optical navigation module may further include a data processing unit electrically connected to the light sensor. The data processing unit is configured to convert the subsequent change of the spatial intensity profile collected by the light sensor into information regarding the motion of the object.

The light source may include a laser that emits coherent light. The laser may be a vertical-cavity surface-emitting laser. The light source may be configured to emit light that has a wavelength of 850 nm.

The light sensor may include an array of light sensing pixels. The spatial intensity profile may include a speckle pattern. The second optical construction may include an aperture. The second optical construction may include a lens, a prism, a mirror assembly, or a plurality of light guiding structures each independently carrying a spatially separated portion of the reflected light to the light sensor.

The module surface may be the outermost surface of a window plate that is made of material that selectively transmits the light emitted by the light source. The window plate may only transmit light in the invisible light spectrum.

In another aspect, the optical navigation module includes a module surface above which the object is disposed; a light source located under the module surface and configured to project a first cone of light to the object along a first optical axis through a first optical construction; a light sensor located under the module surface and configured to detect a second cone of light that is resulted from the first cone of light being reflected by the object along a second optical axis through a second optical construction, and thereby to collect a spatial intensity profile of the reflected light; and a data processing unit electrically connected to the light sensor. The intersection of the first optical axis and the second optical axis is below the module surface. The data processing unit is configured to convert the subsequent change of the spatial intensity profile collected by the light sensor into information regarding the motion of the object. The module surface is the outermost surface of a window plate that is made of material that selectively transmits the light emitted by the light source.

In yet another aspect, the optical navigation module includes a module surface above which the object is disposed; a light source located under the module surface and configured to project a first cone of light to the object along a first optical axis through a first optical construction; a light sensor located under the module surface and configured to detect a second cone of light that is resulted from the first cone of light being reflected by the object along a second optical axis through a second optical construction, and thereby to collect a spatial intensity profile of the reflected light; and a data processing unit electrically connected to the light sensor. The intersection of the first optical axis and the second optical axis is below the module surface. The data processing unit is configured to convert the subsequent change of the spatial intensity profile collected by the light sensor into information regarding the motion of the object. The second optical construction includes an aperture.

### BRIEF DESCRIPTIONS OF THE DRAWINGS

FIG. 1 illustrates an optical navigation module according to an embodiment of the present patent application.

FIG. 2 schematically illustrates the optical navigation module depicted in FIG. 1 from the perspective of geometrical optics.

FIG. 3 schematically shows a top view of the optical navigation module in FIG. 1.

FIG. 4 illustrates an optical navigation module according to another embodiment of the present patent application.

FIG. 5 shows a graph of relative intensity received by the light sensor versus the vertical distance of the object surface from the module surface.

### DETAILED DESCRIPTION

Reference will now be made in detail to a preferred embodiment of the optical navigation module disclosed in the present patent application, examples of which are also provided in the following description. Exemplary embodiments of the optical navigation module disclosed in the present patent application are described in detail, although it will be apparent to those skilled in the relevant art that some features that are not particularly important to an understanding of the optical navigation module may not be shown for the sake of clarity.

Furthermore, it should be understood that the optical navigation module disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

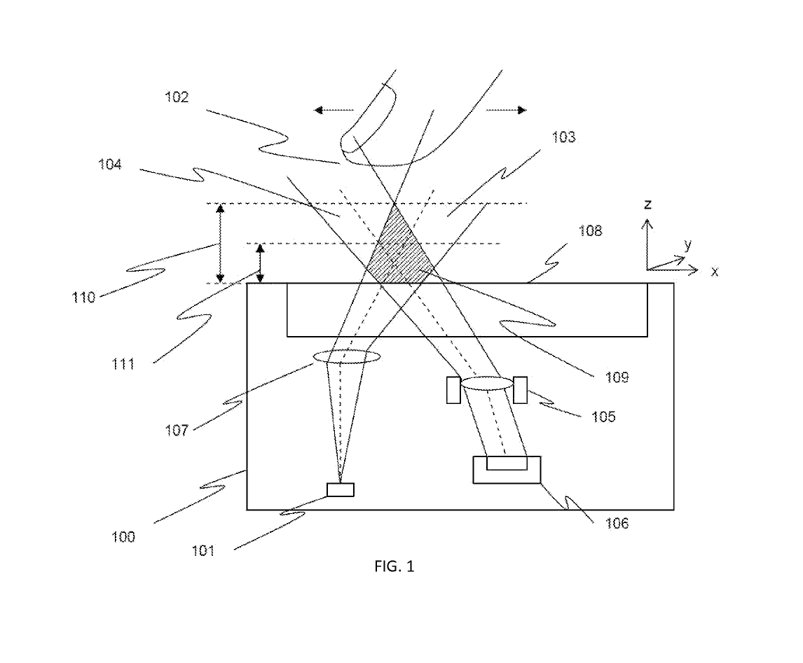

FIG. 1 illustrates an optical navigation module according to an embodiment of the present patent application. Referring to FIG. 1, the optical navigation module 100 is configured to detect the motion of an object. The optical navigation module 100 includes a light source 101 which illuminates the surface of the object 102 positioned above a module surface 108 by a cone of illumination light 103. In this embodiment, the object 102 is a finger of a user. The surface of the object 102 reflects the illumination light 103. Part of the reflected light 104 travels through an aperture 105 to a light sensor 106, which is sensitive to a spectrum including the wavelength of the light emitted by the light source 101. Reflection by the object surface can be in the form of specular or scattered reflection or both.

The motion of the object 102 induces a change in the spatial intensity profile of the reflected light projected on the light sensor 106. The light sensor 106 is a light sensing pixel array configured for capturing the spatial intensity profile of the reflected light. By comparing the current and subsequent spatial intensity profiles, the direction and distance that the object moves on the x-y plane can be determined by a data processing unit electrically connected to the light sensor 106, which may be optionally included in the optical navigation module. The data processing unit in this embodiment includes a microprocessor. Alternatively, the optical navigation module may not include the data processing unit while the data processing unit is externally connected to the optical navigation module. If the light source 101 is incoherent, the light sensor 106 captures the image of the illuminated surface of the object 102. Otherwise, if the light source 101 is coherent, the light sensor 106 captures a speckle pattern formed by the reflected light 104 projected on the light sensor array 106.

The aperture 105 can be incorporated in a lens or prism disposed along the reflected light path to the light sensor 106 depending on the construction of the light sensing optical system. The aperture 105 may also include a mirror assembly or a number of light guiding structures each independently carrying a spatially separated portion of the reflected light to the light sensor 106. There may also be lens structures 107 or prism structures disposed along the illumination light path depending on the construction of illumination optics.

In this embodiment, the module surface 108 is the outermost surface of a window plate that is made of material that selectively transmits the light emitted by the light source 101. The window plate, preferably only transmits light in the invisible light spectrum.

The size, orientation and position of the aperture 105 together with the light sensor area determine the geometry of the cone of light that is able to reach the light sensor 106. This cone of reflected light 104 receivable by light sensor 106 and the cone of illumination light 103 overlap to form a region above the module surface 108 representing the sensing region 109 of the module. The reflected light 104 can reach the light sensor 106 and thus the motion of the object 102 can be detected only when the surface of the object 102 is inside this sensing region 109. The height 110 of this sensing region 109 from the module surface 108 defines the maximum sensing range of this module.

Referring to FIG. 1, the actual sensing range 111 depends on the threshold sensitivity of the light sensor 106 and the surface properties of the surface of the object 102 to be detected, and should be within the maximum sensing range 110. For finger navigation applications, the sensing range is generally required to be small, typically less than 0.5 mm, so that the module is only sensitive to the finger motion when the finger is almost in contact with the finger navigation module.

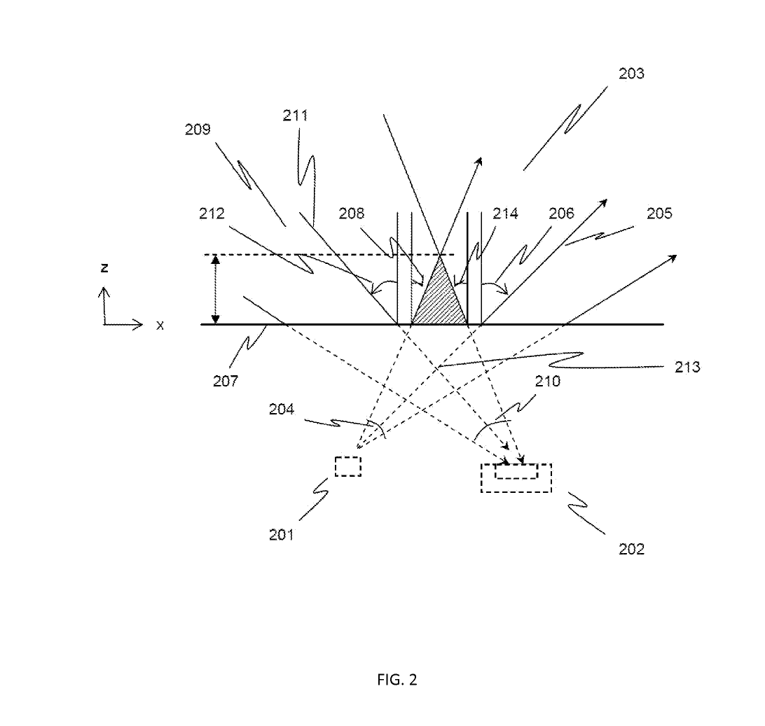

FIG. 2 schematically illustrates the optical navigation module depicted in FIG. 1 from the perspective of geometrical optics. Referring to FIG. 2, the virtual light source 201 is the virtual image of the real light source while the virtual light sensor 202 is the virtual image of the real light sensor. The virtual light source 201 emits a cone of light beam 203 subtending an angle of φₑₘᵢₜ 204 in air (φₑₘᵢₜ is negative if the cone illuminating on the object surface is converging). The illumination chief ray, which runs along the optical axis of illumination 205, makes an angle θ_{cr}_{_{—}}ₑₘᵢₜ 206 with the normal of the module surface 207. The angle that the upper marginal ray θᵤₚ_{_{—}}ₘᵣ_{_{—}}ₑₘᵢₜ 208 makes with the normal of the module surface 207 is given by:

$${θ}_{up\_mr \_emit} \approx {θ}_{cr\_emit} - \frac{{φ}_{emit}}{2} . \qquad ( 1 )$$

Similarly, the virtual light sensor 202 receives a cone of light 209 subtending an angle of θ_{refl} 210 in air (φ_{refl} is negative if the cone tracing from the module surface 207 back to the object surface is converging). The chief ray, which runs along the optical axis 211 of this cone of detectable light, makes an angle θ_{cr}_{_{—}}_{refl} 212 with the normal of the module surface 207 and it intersects the optical axis of illumination 205 at the position 213. The angle that the upper marginal ray θᵤₚ_{_{—}}ₘᵣ_{_{—}}_{refl} 214 makes with the normal of the module surface 207 is given by:

$${θ}_{up\_mr \_refl} \approx {θ}_{cr\_refl} - \frac{{φ}_{refl}}{2} . \qquad ( 2 )$$

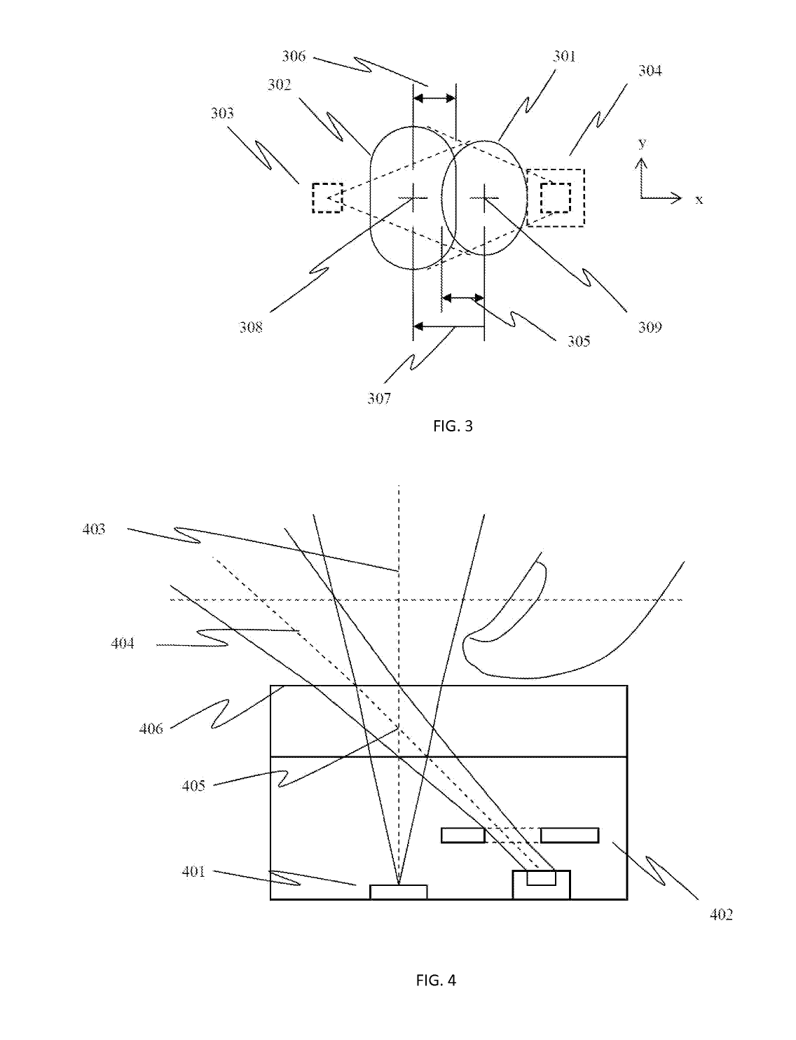

FIG. 3 schematically shows a top view of the optical navigation module in FIG. 1. Referring to FIG. 3, the light spot 301 of the illumination cone of light, the light spot of the cone of reflected light 302 receivable by the light sensor, the virtual light source 303 and the virtual light sensor 304 projected on the module surface along the x-y plane are illustrated. rᵤₚ_{_{—}}ₘᵣ_{_{—}}ᵣₘᵢₜ 305 and rᵤₚ_{_{—}}ₘᵣ_{_{—}}_{refl} 306 are the radii of light spots at where the upper marginal rays of the cone of illumination and the cone of reflected light intercepting the module surface along the x-axis respectively. d 307 is the displacement of position of the optical axis of the cone of reflected light 308 relative to the position of the optical axis of the cone of illumination 309 on the module surface. If the position of the optical axis of the cone of reflected light 308 projected on the module surface is at between the projected virtual light source position 303 and the projected position of the optical axis of the cone of illumination 309, the displacement d 307 is negative.

Then the maximum sensing range can be found by:

$${h}_{max} = \frac{{r}_{up\_emit} + {r}_{up\_refl} + d}{tan {θ}_{up\_mr \_emit} + tan {θ}_{up\_mr \_ref l}} . \qquad ( 3 )$$

The actual sensing range can be equal to hₘₐₓ when the light sensor is able to respond to reflected light no matter how small the optical power is. So in the real case, the actual sensing range will be a fraction of hₘₐₓ depending on the sensitivity of the light sensor and the object's surface properties such as reflectivity and diffusiveness.

In order to have a small value of hₘₐₓ, the denominator of equation (3) have to be large while the numerator have to be kept small. Large θᵤₚ_{_{—}}ₘᵣ_{_{—}}ₑₘᵢₜ and θᵤₚ_{_{—}}ₘᵣ_{_{—}}_{refl} are not desired because they indicate that the cones of illumination light and reflected light receivable by the light sensor lie at very oblique orientation which forces the optical navigation module to be large in size. For the numerator, since both rᵤₚ_{_{—}}ₘᵣ_{_{—}}ₑₘᵢₜ and rᵤₚ_{_{—}}ₘᵣ_{_{—}}_{refl} are positive, the most efficient way to attain a small hₘₐₓ is to design the module with a negative d (d<0), which corresponds to the intersection point of the optical axis of the cone of illumination and the optical axis of the cone of reflected light receivable by the light sensor is below the module surface. In this way, the illumination part and the light sensing part are brought closer together, which is favorable to small module size.

FIG. 4 illustrates an optical navigation module according to another embodiment of the present patent application. In this embodiment, the light source 401 is a VCSEL (vertical-cavity surface-emitting laser) and the aperture 402 is simply a slit structure. In this embodiment, the VCSEL is configured to emit light that has a wavelength of 850 nm. The optical axis of the cone of illumination 403 and the optical axis the cone of reflected light 404 intersect at the position 405 below the module surface 406.

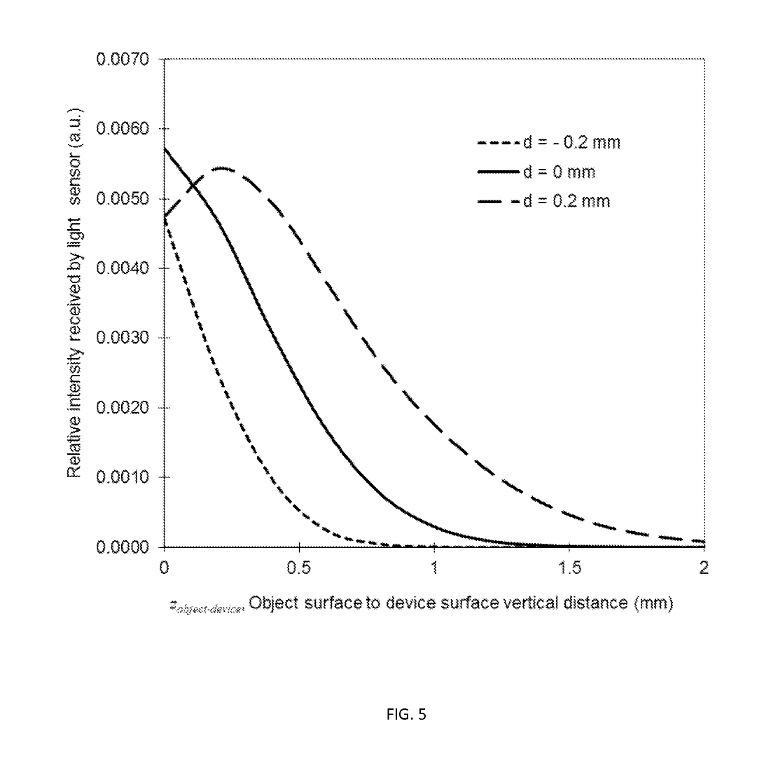

FIG. 5 shows a graph of relative intensity received by the light sensor versus the vertical distance of the object surface from the module surface, z_{object-module}, for the designs of d=0.2 mm (d>0), d=0 mm and d=−0.2 mm (d<0) for the embodiment shown in FIG. 4. Referring to FIG. 5, in the case of d=0.2 mm, the intensity received by the light sensor has a local maximum. The intensity drops with the increase of Z_{object-module} only when z_{object-module} is greater than the point corresponding to the local maximum intensity. Therefore, hₘₐₓ will be higher than that in the other cases. In the cases of d=0 mm and d=−0.2 mm, the intensity drops with the increase of z_{object-module} monotonically and with a steeper slope, which enables a small hₘₐₓ value. According to equation (3), hₘₐₓ is found to be 1.2 mm for the case of d=−0.2 mm. The actual experimental sensing range is around 0.5 mm which is within the calculated range.

Possible applications of the above embodiments can be optical mice, laptop computers, handheld devices, and any other consumer electronics requiring user input through a GUI (Graphical User Interface). The module can take any desired shape according to the appearance requirements, such as a round shape, a rectangular shape, and etc.

While the present patent application has been shown and described with particular references to a number of embodiments thereof, it should be noted that various other changes or modifications may be made without departing from the scope of the present invention.

What is claimed is:

1. An optical navigation module for receiving control from an object, the optical navigation module comprising:
a module surface above which the object is disposed;
a light source located under the module surface and configured to project a first cone of light to the object along a first optical axis through a first optical construction; and
a light sensor located under the module surface and configured to detect a second cone of light that is resulted from the first cone of light being reflected by the object along a second optical axis through a second optical construction, and thereby to collect a spatial intensity profile of the reflected light; wherein:
the intersection of the first optical axis and the second optical axis is below the module surface.

2. The optical navigation module of claim 1 further comprising a data processing unit electrically connected to the light sensor, wherein the data processing unit is configured to convert the subsequent change of the spatial intensity profile collected by the light sensor into information regarding the motion of the object.

3. The optical navigation module of claim 1, wherein the light source comprises a laser that emits coherent light.

4. The optical navigation module of claim 3, wherein the laser is a vertical-cavity surface-emitting laser.

5. The optical navigation module of claim 3, wherein the light source is configured to emit light that has a wavelength of 850 nm.

6. The optical navigation module of claim 1, wherein the light sensor comprises an array of light sensing pixels.

7. The optical navigation module of claim 1, wherein the spatial intensity profile comprises a speckle pattern.

8. The optical navigation module of claim 1, wherein the second optical construction comprises an aperture.

9. The optical navigation module of claim 1, wherein the second optical construction comprises a lens, a prism, a mirror assembly, or a plurality of light guiding structures each independently carrying a spatially separated portion of the reflected light to the light sensor.

10. The optical navigation module of claim 1, wherein the module surface is the outermost surface of a window plate that is made of material that selectively transmits the light emitted by the light source.

11. The optical navigation module of claim 10, wherein the window plate only transmits light in the invisible light spectrum.

12. An optical navigation module for receiving control from an object, the optical navigation module comprising:
a module surface above which the object is disposed;
a light source located under the module surface and configured to project a first cone of light to the object along a first optical axis through a first optical construction;
a light sensor located under the module surface and configured to detect a second cone of light that is resulted from the first cone of light being reflected by the object along a second optical axis through a second optical construction, and thereby to collect a spatial intensity profile of the reflected light; and
a data processing unit electrically connected to the light sensor; wherein:
the intersection of the first optical axis and the second optical axis is below the module surface;
the data processing unit is configured to convert the subsequent change of the spatial intensity profile collected by the light sensor into information regarding the motion of the object; and
the module surface is the outermost surface of a window plate that is made of material that selectively transmits the light emitted by the light source.

13. The optical navigation module of claim 12, wherein the light source comprises a laser that emits coherent light.

14. The optical navigation module of claim 13, wherein the laser is a vertical-cavity surface-emitting laser.

15. The optical navigation module of claim 12, wherein the spatial intensity profile comprises a speckle pattern.

16. The optical navigation module of claim 12, wherein the second optical construction comprises a lens, a prism, a mirror assembly, or a plurality of light guiding structures each independently carrying a spatially separated portion of the reflected light to the light sensor.

17. The optical navigation module of claim 12, wherein the window plate only transmits light in the invisible light spectrum.

18. The optical navigation module of claim 13, wherein the light source is configured to emit light that has a wavelength of 850 nm.

19. The optical navigation module of claim 12, wherein the light sensor comprises an array of light sensing pixels.

20. The optical navigation module of claim 12, wherein the second optical construction comprises an aperture.

21. An optical navigation module for receiving control from an object, the optical navigation module comprising:
a module surface above which the object is disposed;
a light source located under the module surface and configured to project a first cone of light to the object along a first optical axis through a first optical construction;
a light sensor located under the module surface and configured to detect a second cone of light that is resulted from the first cone of light being reflected by the object along a second optical axis through a second optical construction, and thereby to collect a spatial intensity profile of the reflected light; and
a data processing unit electrically connected to the light sensor; wherein:
the intersection of the first optical axis and the second optical axis is below the module surface;
the data processing unit is configured to convert the subsequent change of the spatial intensity profile collected by the light sensor into information regarding the motion of the object; and
the second optical construction comprises an aperture.

22. The optical navigation module of claim 21, wherein the second optical construction further comprises a lens, a prism, a mirror assembly, or a plurality of light guiding structures each independently carrying a spatially separated portion of the reflected light to the light sensor.

23. The optical navigation module of claim 21, wherein the module surface is the outermost surface of a window plate that is made of material that selectively transmits the light emitted by the light source, and the window plate only transmits light in the invisible light spectrum.

24. The optical navigation module of claim 21, wherein the light source comprises a laser that emits coherent light.

25. The optical navigation module of claim 24, wherein the laser is a vertical-cavity surface-emitting laser.

26. The optical navigation module of claim 24, wherein the light source is configured to emit light that has a wavelength of 850 nm.

27. The optical navigation module of claim 21, wherein the light sensor comprises an array of light sensing pixels.

28. The optical navigation module of claim 21, wherein the spatial intensity profile comprises a speckle pattern.
